(19) United States
(12) Patent Application Publication
(10) Pub. No.: US 2004/0242029 A1
(43) Pub. Date: Dec. 2, 2004

(54) Writing apparatus, semiconductor memory card, writing proguram, and writing method

(76) Inventors: Norio Nakamura, Ikoma-gun (JP); Shinichi Matsui, Kobe-shi (JP); Shunji Harada, Osaka-shi (JP); Kazuya Fujimura, Ikoma-shi (JP); Kaoru Murase, Nara-shi (JP); Naohiko Noguchi, Yokohama-shi (JP); Kiichi Hasegawa, Yokohama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/483,814

(22) PCT Filed: Jul. 16, 2002
(86) PCT No.: PCT/JP02/07192

(30) Foreign Application Priority Data
Jul. 18, 2001 (JP) 2001-217765

(51) Int. Cl. H01R 12/00

(52) U.S. Cl. 439/66; 439/60

(57) ABSTRACT

The card writer (101) detects whether the sliding member (1) constituting the slide switch of the SD memory card is in the first position or the second position. The device driver (60) of the host computer (100) sets the memory area within the SD memory card to the writable state when the sliding member is in the first position. On the other hand, when the sliding member is in the second position, the device driver sets the memory area to the non-writable state except a part of the memory area. This part is the protected area (25) that is writable even when the protected area (25) is set to the non-writable state.

### TECHNICAL FIELD

The present invention relates to a writing apparatus for writing data into a semiconductor memory card, a semiconductor memory card, a writing program, and a writing method, and particularly to improvement in the above techniques when a semiconductor memory card is provided with a slide switch for protection of data recorded thereon.

### BACKGROUND ART

In order to prevent unintentional deletion or overwriting of data recorded thereon, a semiconductor memory card is provided with a slide switch used to put the semiconductor memory card to a writable state or a non-writable state. By shifting a sliding member of the slide switch with the fingers, a user is allowed to set the semiconductor memory card to either a writable state or a non-writable state. The following describes how a conventional writing apparatus writes data onto such a semiconductor memory device as above. When attempting to write data onto the memory card, an application program running within a conventional writing apparatus requests a device driver to write data. In response, the device driver detects the position of the sliding member. When the sliding member is set in the position indicating the writable state, the device driver writes the data as requested by the application. On the other hand, when the sliding member is set in the position indicating the non-writable state, the device driver does not write the data, but informs the application that the slide switch is in the position indicating the non-writable state. Being informed that the memory card is set in the non-writable state, the application then informs the user that writing of data has failed, and prompts the user to re-set the slide switch to the position indicating the writable state.

The timing when writing of data as described above is performed differs depending on the type of application. When running an end user application, such as an editor or a browser, writing of data is requested in response to an explicit user operation, such as a file save operation. On the contrary, when running a system application, writing of data may be requested although user makes no operation.

Consider now the case where a system application requests a device driver to write data in spite of user operations, and the data can not be written because the slide switch is in the position indicating the non-writable state. As a consequence, the device driver prompts the user to change the switch setting. In user's point of view, it is not preferable at all that the application urges the user to change the switch setting although the user has given no instruction for writing of data. This is especially true considering that the user has intentionally set the slide switch in the position indicating the non-writable state to protect the data recorded on the semiconductor memory card from destruction. Being required to change the setting into writable state merely for the application sake despite his intention, the user in this regard is more like being directed by the application, which may be offensive. In addition, a software house or a developer of system applications tends to avoid requiring in their programs write operations to the memory card set to the non-writable state. In an attempt to program system applications with least write operations to a memory card that may be set to the non-writable state, programmers developing the system applications are likely to put pressure on themselves, which possibly hinder development of system applications.

### DISCLOSURE OF THE INVENTION

It is an object of the present invention to provide a writing apparatus that allows a system application program to write data into a semiconductor memory card without requiring a user to change the setting of a slide switch of the semiconductor memory card.

The above object can be achieved by a writing apparatus that writes data into a user area within a semiconductor memory card according to an instruction issued by an application program. The writing apparatus comprises: a recognition unit operable to recognize the user area to be in a writable state or in a non-writable state depending on a position of a sliding member, the sliding member being exposed on a surface of the semiconductor memory card and being manually slidable; a write unit operable to write data into the user area in the writable state, and when the user area is in the non-writable state, to perform an exceptional write operation. The exceptional write operation is performed according to a special write command issued by the application program to write data into a memory area within the semiconductor memory card that is different from the user area.

With this construction, a system application is allowed to write data into the semiconductor memory card even in the case where the user sets the sliding member to protect the data stored in the semiconductor memory card from being unintentionally deleted. The system application is allowed to perform such a write operation without requiring the user to change the slide switch setting, and thus without bothering the user. In other words, regardless of the non-writable state set by the slide switch, the system application is allowed to write data into the semiconductor memory card without bothering the user. This feature provides more flexibility in developing system applications, and thus helps to develop programs with efficiency.

Here, the semiconductor memory card may have an authentication circuit. The special write command may include (i) an instruction for directing the writing apparatus to authenticate the semiconductor memory card, and (ii) an instruction for directing the authentication circuit of the semiconductor memory card to authenticate the writing apparatus. The exceptional write operation may be performed only when the writing apparatus and the semiconductor memory card are authenticated mutually and successfully.

With this construction, the memory card of which slide switch is set for the non-writable state is exceptionally writable only when mutual authentication processing is successfully performed. That is, the exceptional write operation is performed only by an application having a right to instruct mutual authentication processing and not allowed for all the applications.

In addition, since only system applications are permitted to write data onto the memory card set in the partially writable state, end user applications are not permitted to write data into the memory area. That is, this construction achieves the essential object to prevent unintentional deletion of data by users.

### BRIEF DESCRIPTION OF THE DRAWINGS

FIG. 1 is a view showing the construction of a writing apparatus;

FIGS. 2A and 2B are views showing the external representation of a semiconductor memory card;

FIG. 3A is a view showing the semiconductor memory card with a sliding member 1 constituting a slide switch fixed in a first position;

FIG. 3B is a view showing the semiconductor memory card with the sliding member 1 fixed in a second position;

FIG. 4 is an enlarged view showing the slide switch;

FIG. 5 is a view showing the respective layer structures of a host computer 100, a card writer 101, and the semiconductor memory card 102;

FIG. 6 is a view showing the internal construction of the card writer 101;

FIG. 7A is a view showing a slide position detection unit 7 when the semiconductor memory card 102 is loaded to the card writer 101 with the sliding member 1 set in the second position;

FIG. 7B is a view showing the slide position detection unit 7 when the semiconductor memory card 102 is loaded to the card writer 101 with the sliding member 1 set in the first position;

FIG. 8 is the flowchart showing the processing performed by the device driver 60 to generate state information;

FIG. 9 is a view showing one example of the state information;

FIGS. 10A and 10B are views showing operations performed by the layers shown in FIG. 5 to check the state of semiconductor memory card 102;

FIG. 11 is a view showing the respective layer structures of the host computer 100, the card writer 101, and the semiconductor memory card 102 all in consistent with the second embodiment;

FIG. 12 is a view showing the hardware construction of the SD memory card;

FIG. 13 is a view showing the sequence of a secure write protocol;

FIG. 14 is a view showing the operations performed to read the content and the usage condition information from the SD memory card;

FIG. 15 is a view showing the operations performed to write data into the SD memory card; and

FIG. 16 is a view showing the internal construction of an SD memory card consistent with a third embodiment.

### BEST MODE FOR CARRYING OUT THE INVENTION

### First Preferred Embodiment

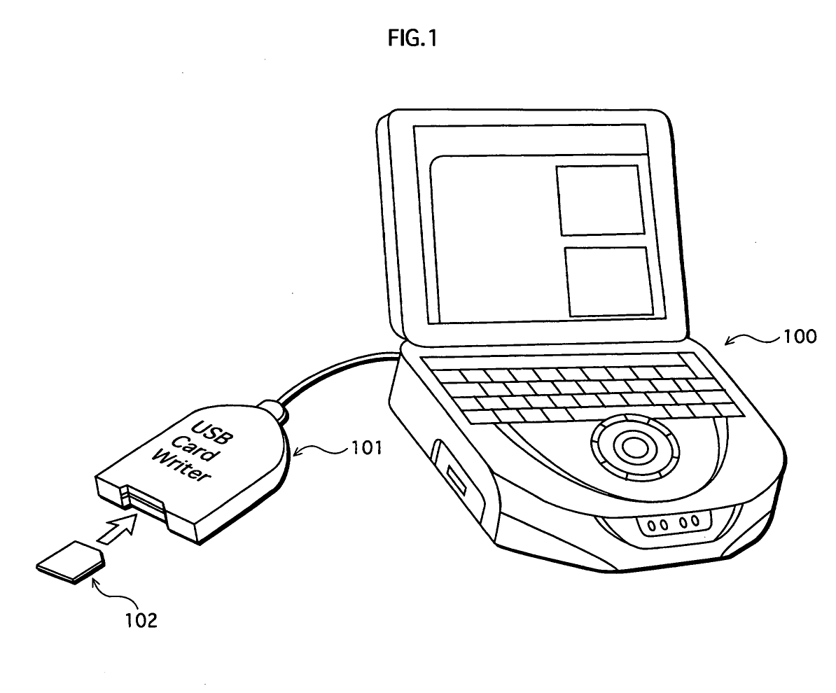

The following describes a writing apparatus consistent with a first embodiment of the present invention. FIG. 1 is a view showing a construction of the writing apparatus. As shown in the figure, the writing apparatus includes a host computer 100 and a card writer 101, and writes data onto a semiconductor memory card 102. The host computer 100 and the card writer 101 are connected via a USB cable. The semiconductor memory card 102 may be either of two types: an SD (Secure Digital) memory card and a flash memory card. Regardless of the type, the semiconductor memory card 102 internally includes EEPROM and a controller 20. An SD memory card differs from a flash memory card in that the SD memory card has a protected area while the flash memory card does not. The protected area referred herein is a memory area that is accessible from a device connected to the semiconductor memory card 102 only when mutual authentication processing is successfully performed between the semiconductor memory card 102 and the device. Such data necessary for license management or accounting processing is recorded in the protected area. On the contrary, memory area that is accessible without mutual authentication processing is referred to as a user data area.

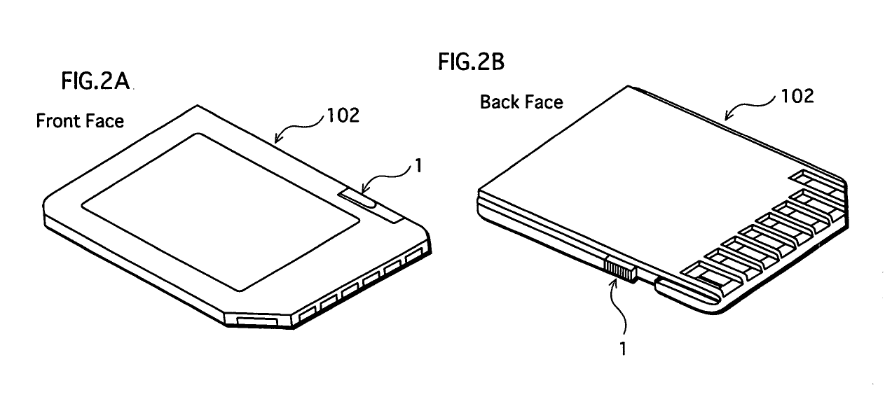

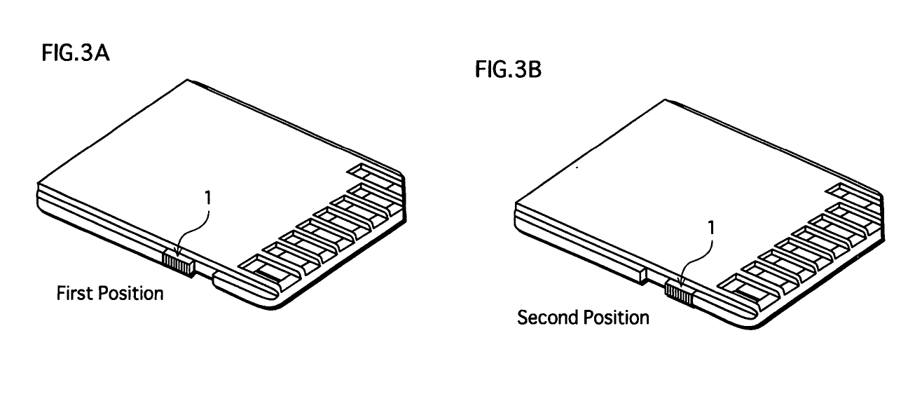

The semiconductor memory card 102 has an external representation as shown in FIGS. 2A and 2B. The memory card 102 is approximately 32.0 mm long, 24.0 mm wide, and 2.1 mm thick, which is the size small enough to hold with the fingertips (the size of a postage stamp). Provided below the under surface of the semiconductor memory card 102 are nine connectors for connection with the card writer 101, and provided on the lateral side is a slide switch. The user sifts a sliding member 1 constituting the slide switch to either a second position on the side closer to the connector, or a first position on the other side. FIG. 3A shows the sliding member set in the first position, while FIG. 3B shows the sliding member set in the second position. The sliding member 1 set in the second position indicates user's intention to set the semiconductor memory card 102, i.e., EEPROM installed therein, to the “non-writable” state, whereas the sliding member 1 set in the first position shows user's intention to set the semiconductor memory card 102, i.e., EEPROM, into “the writable” state.

The wording “to indicate user's intention” means that the sliding member 1 is not in conjunction with any components constituting the semiconductor memory card 102. The sliding member 1 is more like a decoration than a component performing some sort of actions, such as physically connecting or breaking a circuit provided within the semiconductor memory card 102. This is because the semiconductor memory card 102 has to be small and manufactured at low cost. To this end, it is practically difficult to provide a mechanism to connect or break the internal circuit of the semiconductor memory card 120. It is up to the card writer 101 and the host computer 100 that detect the switch setting to decide what operations to perform in response to the sliding member set in the first position or the second position.

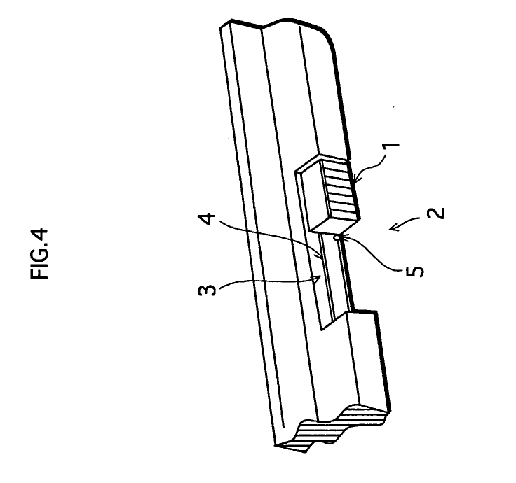

FIG. 4 is an enlarged view showing the slide switch. The slide switch includes a notch 2, and a guide groove 4 provided in an end surface 3 of the notch 2, so that a user can slide the sliding member 1 along the guide groove 4. At the middle of the end surface 3 is a protrusion 5. Being encaged with the protrusion 5, the sliding member 1 is fixed in either the first position or the second position. This concludes the description of the semiconductor memory card 102.

Next, description is given separately to the internal constructions of the host computer 100, the card writer 101, and the semiconductor memory card 102.

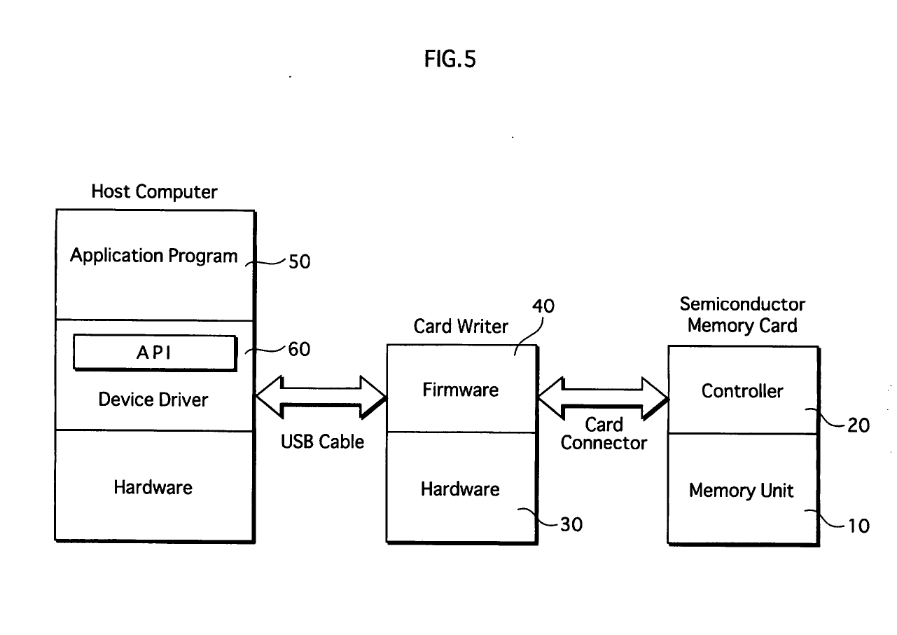

FIG. 5 is a view showing the respective layer structures of the host computer 100, the card writer 101, and the semiconductor memory card 102. The semiconductor memory card 102 includes a memory unit 10 and a controller 20, which are layers arranged in the stated order. The card writer 101 includes a piece of hardware 30 and a piece of firmware 40 which are layers arranged in the stated order. The host computer 100 includes a piece of hardware, a device driver 60, and an application program 50 which are layers arranged in the stated order.

First, description is given to the components (i.e., the memory unit 10 and the controller 20) of the semiconductor memory card 102.

The memory unit 10 includes EEPROM and accessible form the application program 50 included in the host computer 50. The details of the memory unit 10 are given below in a second preferred embodiment, and thus description of the memory unit 10 in this embodiment is concluded here.

The controller 20 reads and writes data recoded in the memory unit 10 included in the semiconductor memory card 102 in response to a request from the application program 50. The details of the read operations and write operations by the controller 20 are also given in the second preferred embodiment, and thus description of the controller 20 in this embodiment is concluded here.

Now, description is given to the components (i.e., the hardware 30 and the firmware 40) of the card writer 101.

The hardware 30 includes a plug for connecting the semiconductor memory card 102, and a slide position detection unit for detecting a position of the sliding member constituting the slide switch of the semiconductor memory card 102.

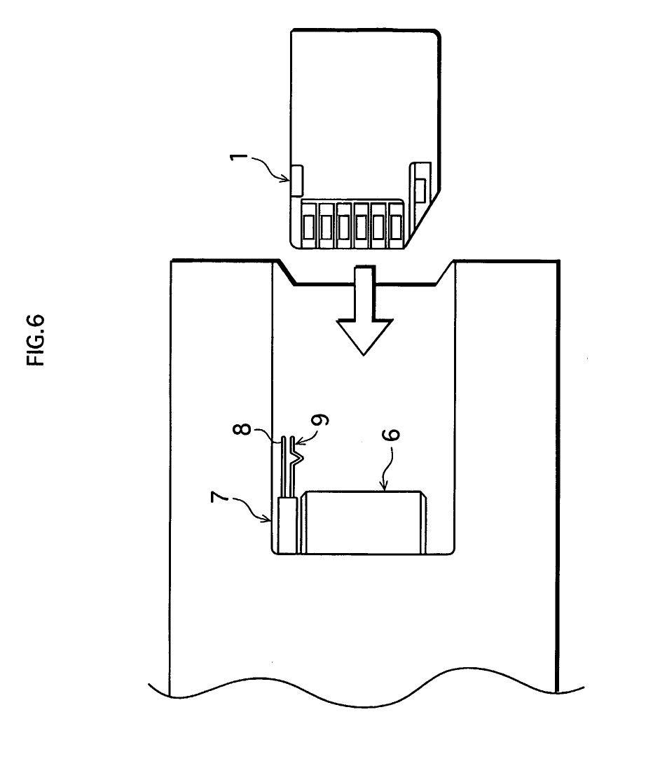

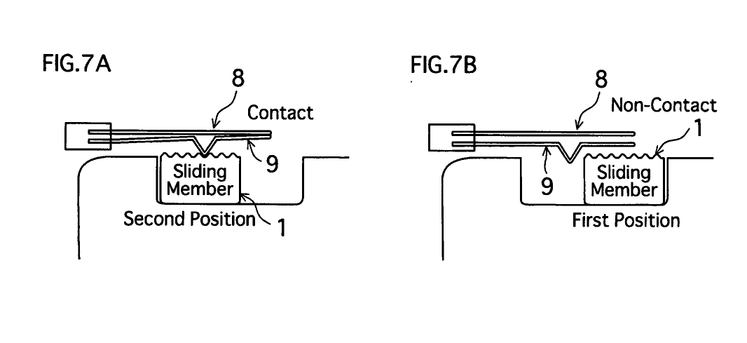

FIG. 6 is a view showing the internal construction of the card writer 101. To load the semiconductor memory card 102 to the card writer 101, the connector of the semiconductor memory card 102 is inserted into a plug 6 shown in this figure. There is provided a slide position detection unit 7 in such a position that contacts the sliding member 1 when the semiconductor memory card 102 is loaded. The slide position detection unit 7 is composed of opposing two metal pieces 8 and 9, and the metal piece 9 has a U-bend portion. As shown in FIG. 7A, when the semiconductor memory card 102 is loaded to the card writer 101 with the sliding member 1 set in the second position, the U-bend portion of the metal piece 9 is pressed by the sliding member 1 into contact with the metal piece 8 at their ends. On the other hand, as shown in FIG. 7B, when the semiconductor memory card 102 is loaded to the card writer 101 with the sliding member set in the first position, the U-bend portion is not pressed and thus the two metal pieces 7 and 8 stay out of contact. By electrically detecting contact and non-contact between the two metal pieces, it is detected whether the sliding member 1 is in the second position or the first position. (Note that the slide position detection unit 7 is so constructed that the two metal pieces 8 and 9 stay out of contact when a semiconductor memory card 102 with no slide switch is loaded into the card writer 101.)

The firmware 40 receives an inquiry from the device driver 60 of the host computer 100 via the USB cable. In response to such an inquiry, the firmware 40 passes to the host computer 100 whether the sliding member 1 of the semiconductor memory card 102 is in the second position or the first position. At the same time, the firmware 40 detects whether the semiconductor memory card loaded to the card writer 101 is an SD memory card type or a flash memory card type, and passes the detected card type to the host computer 100.

Next, description is given to the components (i.e., the application program 50 and the device driver 60) of the host computer 100.

The application program 50 is of either of the following two types: a system application and an end user application. An end user application is, for example, an editor for creating document and image, or a browser for browsing www sites, and performs write operations to the semiconductor memory card 102 in accordance with user operations. On the other hand, a system application is, for example, a program for license management, accounting management, or personal information management, and performs write operations to the semiconductor memory card 102 independently of user operations. In this embodiment, distinction between system applications and end user applications is made based on whether each application is capable of mutual authentication processing that is required to access the protected area of an SD memory card. An application capable of mutual authentication processing is a system application, and an application program incapable of such processing is an end user application. In order to perform the mutual authentication processing, an application needs to be in possession of a device key. The device key is information that is unique to each device, such as the writing apparatus consistent with this embodiment, capable of accessing the SD memory card. The device key is issued by an organization for standardization of copyright protection techniques provided that the software house being the developer of a respective application makes a contract with the organization. The contract usually includes a clause prohibiting development of applications that freely rewrite data in a protected area according to user operations. Thus, these system applications may be capable of doing so but do not write data into the protected area although instructed by a user.

The device driver 60 performs operations including (i) initialization, (ii) state management, and (iii) data input and output on the card writer 101, which the host computer recognizes as one of the “drives.” For the state management of the drive, API (Application Program Interface) of the device driver 60 includes a function (Function DDChkSDCard) for checking whether the semiconductor memory card 102 loaded to the card writer 101 is in the writable state or the non-writable state. An argument to the function DDChkSDCard is the drive name of the card writer 101 of which state should be managed. The wording “drive name” refers to information for identifying a “drive” recognized by the host computer 10.

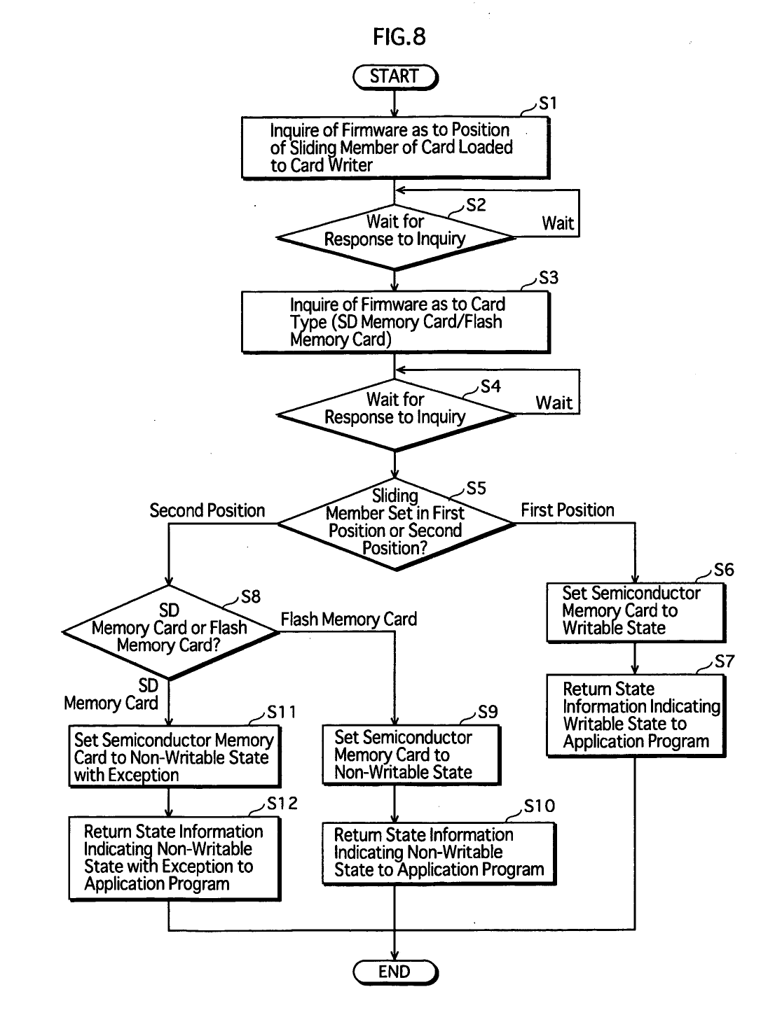

For example, the card writer 101 is allotted the drive name “E:” and to inquire the state of the drive E:, the application program 50 specifies the drive name “E:” to call the function DDChkSDCard(E:). The function DDChkSDCard returns state information regarding the state of semiconductor memory card 102 loaded to the card writer 101. The processing to generate the state information by the device driver 60 is a feature of this embodiment, and described further in detail with reference to the flowchart shown in FIG. 8.

FIG. 8 shows the flowchart showing the processing performed by the device driver 60 to generate the state information. In a step S1, the device driver 60 inquires of the firmware 40 included in the card writer 101 as to the position of the sliding member 1 of the semiconductor memory card 102 that is loaded to the card writer 101. Upon receipt of a response regarding the position of the sliding member 1 (step S2), the device driver 60 inquires of the firmware 40 included in the card writer 101 as to the type of the semiconductor memory card (an SD memory card type or a flash memory card type) in a step S3. Upon receipt of a response regarding the card type, the device driver 60 moves from a step S4 onto a step S5 to judge whether the sliding member 1 is in the first position or the second position. When judging the sliding member 1 is in the first position, the device driver 60 recognizes in a step S6 that the semiconductor memory card 102 is in the writable state. In a step S7 that follows, the device driver 60 generates state information indicating the writable state, and returns the state information to the application program 50 that made the inquiry. On the other hand, when the judgment in the step S5 shows that the sliding member 1 is in the second position, the device driver 60 judges in a step S8 whether the card type is an SD memory card or a flash memory card. When judging the card type to be a flash memory card, the device driver 60 recognizes in a step S9 that the semiconductor memory card 102 is in the non-writable state. In a step S12 that follows, the device driver 60 generates state information indicting the writable state, and returns the state information to the application program 50.

On the other hand, when the judgment in the step S8 shows that the card type is an SD memory card, the device driver 60 recognizes in a step S11 that the semiconductor memory card 102 is in a “non-writable state with exception.” In a step S12 that follows, the device driver 60 returns state information indicating the non-writable state with exception to the application program 50.

The “non-writable state with exception” used herein refers to the state in which a write operation to the user data area is prohibited while a write operation to the protected area is permitted as an exception. That is, the sliding member 1 set in the second position basically puts the SD memory card into the non-writable state, thereby prohibiting a write operation to the user data area. However, a write operation to the protected area is still permitted as an exception.

In this non-writable state with exception, a system application is permitted to perform a write operation to the protected area within the semiconductor memory card 102 even when the user has set the sliding member 1 in the second position to avoid accidentally deleting the stored data. Here, the system application is permitted to perform such a write operation as above without requiring the user to change the slide switch setting, i.e., without bothering the user. Further, when the slide switch is set in the non-writable state, a write operation is exceptionally permitted but only to the protected area. In addition, it is not an end user application but a system application that performs a write operation to the protected area. In other words, in this non-writable state with exception, the stored data is protected from unintentional deletion by the user.

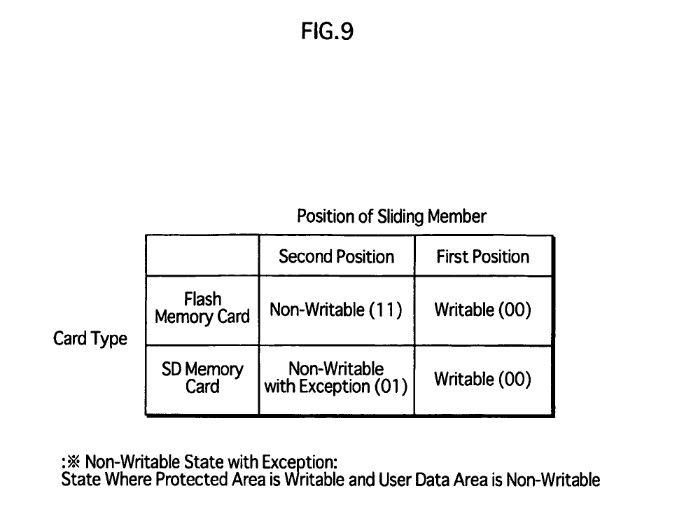

FIG. 9 is a view showing one example of the state information. The state information consists of two bits. The bit pattern “00” represents the semiconductor memory card 102 is in the writable state, and “11” represents the semiconductor memory card 102 is in the non-writable state. In the case the semiconductor memory card 102 is a flash memory card, the state information consists of either the “00” or “11” bits. The “01” bit pattern represents that the semiconductor memory card 102 is in the non-writable state with exception. Thus, in the case the semiconductor memory card 102 is an SD memory card, the state information is consists of either “00” or “01” bits.

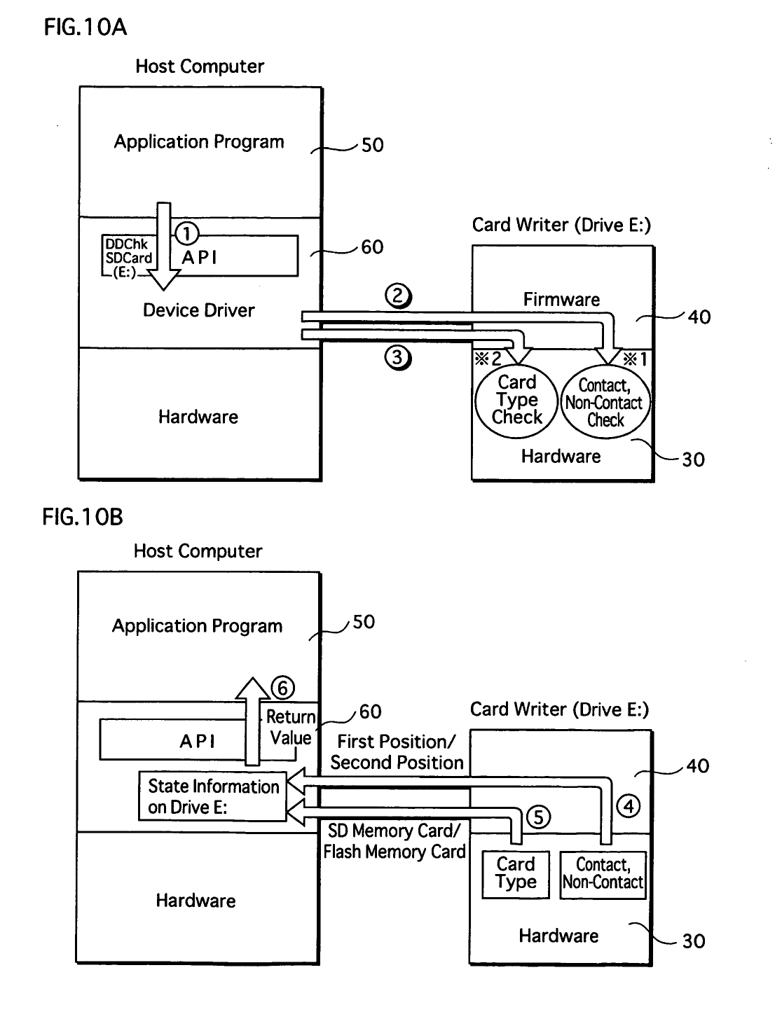

FIGS. 10A and 10B are views showing operations performed by the layers shown in FIG. 5 to check the state of semiconductor memory card 102. When the function DDChkSDCard is performed to call“DDChkSDCard(E:) ” as shown by an arrow \hat{1} in FIG. 10A, the device driver 60 inquires of the firmware 40 about the position of the sliding member 1 and the card type as shown by arrows \hat{2} and \hat{3}, respectively.

In response to the inquiry about the position of the sliding member 1, the firmware 40 detects with the slide position detection unit 7 whether the metal pieces are in contact or non-contact as shown in the figure by the reference mark ⋄1, and also detects the card type of the semiconductor memory card 102 as shown by the reference mark ⋄2. In accordance with the detection results, the firmware 40 notifies the device driver 60 of the host computer 100 about the position of the sliding member 1 and the card type as shown in FIG. 10B by arrows \hat{4} and \hat{5}, respectively. Upon receipt of the notification, the device driver 60 generates state information and gives the generated state information to the application program 50 as shown by an arrow \hat{6} in return for the function call.

As described above, according to this embodiment, a system application is allowed to write data into an SD memory card although the slide switch is set for the non-writable state, and the writing is done without bothering the user. This feature provides more flexibility in developing system applications, and thus helps to develop programs with efficiency.

Note that that the semiconductor memory card 102 in this embodiment is described to have the slide switch. However, there are semiconductor memory cards without a slide switch. In this case, the semiconductor memory card subjected to a writing operation may be set to the writable condition once it is judged in the step S4 or S5 shown in FIG. 8 that the semiconductor memory card is not provided with a slide switch.

### Second Preferred Embodiment

The second embodiment of the present invention relates to an improvement in a writing device for utilizing contents stored in a memory card. There are two applications for realizing usage of such contents.

One applications is for downloading a content from a server over a network to write the content into a user data area within an SD memory card, and also for implementing “usage of the content” including playback or copying of the content.

The other application is an LCM (Licensed Compliant Module) for license management of encrypted contents. The license management by the LCM is to update by the writing apparatus usage condition information recorded in the protected area of the SD memory card in accordance with usage of the content.

To allow for the content to be used, the usage condition information that regulates usage of the content is recorded in the protected area of the SD memory card. The usage condition information includes a permitted number of playback times or a permitted number of copying times corresponding to each content. The LCM updates the usage condition information by decrementing the permitted number of playback times or the permitted number of copying times every time the content is copied or played back by the writing apparatus.

Now, the following describes operations for overwriting the usage condition information upon usage of the content as described above.

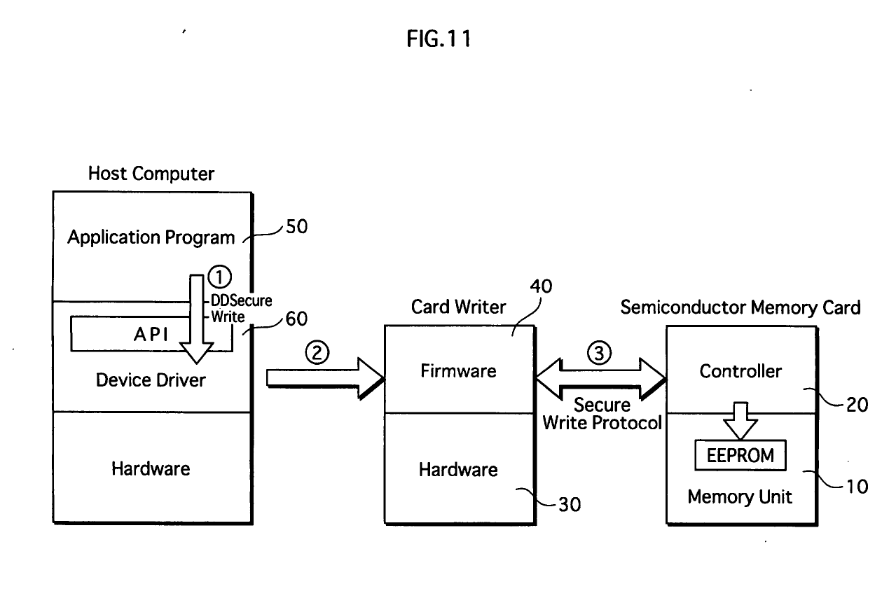

FIG. 11 is a view showing the respective layer structures of the host computer 100, the card writer 101, and the semiconductor memory card 102 all in consistent with the second embodiment.

Here, description is given to improvement in the device driver 60 consistent with the second embodiment. API of the device driver 60 consistent with the second embodiment provides the LCM with the function DDSecureWrite, so that the LCM is able to write data into the protected area. An arrow \hat{1} in FIG. 11 schematically shows that the application program 50 calls the function DDSecureWrite. There are two arguments to the function DDSecureWrite, and as the arguments, (1) a pointer addressing the data to be written, and (2) the size of the data to be written are specified. The application program 50 calls the function DDSecureWrite after opening the file containing the usage condition information, specifying with the file pointer where in the opened file to start writing of the data, thereby instructing the device driver 60 to overwrite the usage condition information.

Next, description is given to improvement in the firmware 40 consistent with the second embodiment. When the function DDSecureWrite is called, the firmware 40 consistent with the second embodiment receives from the device driver 60 the instruction to write the data into the protected area, the data to be written, and the data size, and performs a write protocol in conjunction with the controller 20 included in the SD memory card to carry out the write operation to the protected area. In the figure, an arrow \hat{2} schematically shows data transfer from the device driver 60 to the firmware 40, and an arrow \hat{3} schematically shows the write protocol (secure write protocol) performed between the firmware 40 and the controller 20.

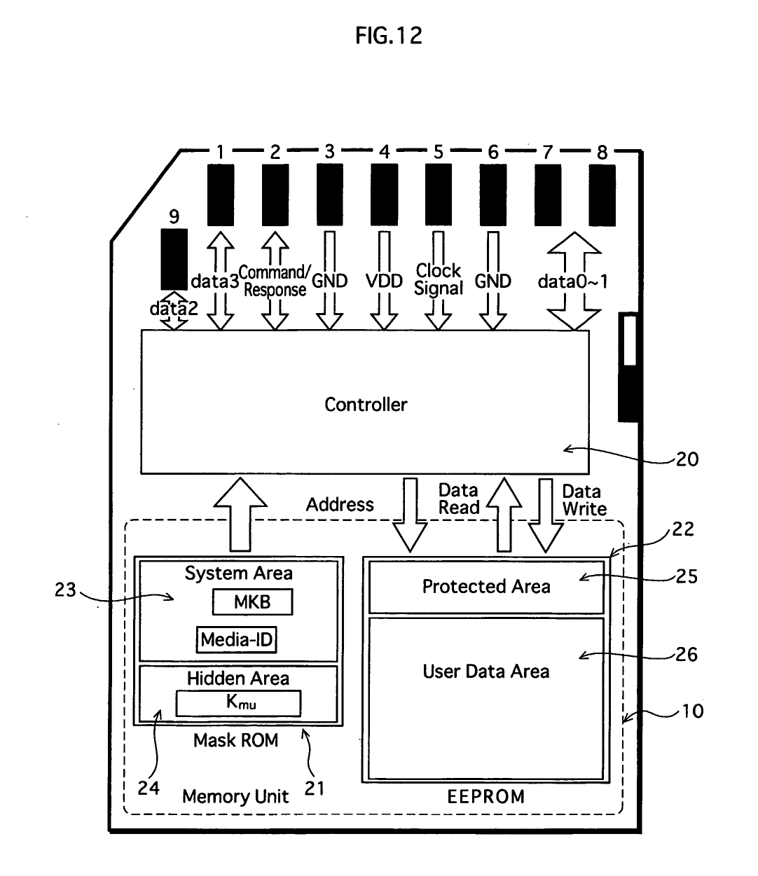

Now, description is given to improvement in the memory unit 10 of the SD memory card consistent with the second embodiment. In the second embodiment, the memory unit 10 has the hardware construction as shown in FIG. 12. FIG. 12 is a view showing the hardware construction of the SD memory card. As shown in the figure, the memory unit 10 of the SD memory card includes a mask ROM 21 and an EEPROM 22, and is connected to the connector of the semiconductor memory card 102 via the controller 20. The mask ROM 21 includes a system area 23 and a hidden area 24. The EEPROM 22 includes a protected area 25 and a user data area 26.

The system area 23 is one area in the mask ROM, and stores a media key block (MKB) and media-ID. The MKB and the media-ID stored in the system area 23 are not rewritable. The MKB and the media ID are read by another device connected to the SD memory card. The device performs a predetermined calculation using the read MKB and media-ID as well as a device key Kd that the device has. Provided that the predetermined calculation is correctly performed, the device obtains a legitimate encryption key Kmu.

Similarly to the system area 23, the hidden area 24 is one area in the mask ROM, and stores the encryption key Kmu, which is the key that another device obtains through a correct calculation using the legitimate device key Kd.

The protected area 25 is one area in the EEPROM 22, and stores the usage condition information.

Similarly to the protected area 25, the user data area 26 is one area in the EEPROM 22. The user data area 26 differs from the protected area 25 in that the user data area 26 is accessible from a device regardless of whether authenticity of the device is verified. The user data area 26 is for storing an encrypted content.

Next, description is given to a controller 20 consistent with the second embodiment. In the second embodiment, the controller 20 of the SD memory card receives data to be written into the SD memory card from the firmware 40 and then writes the data into the memory unit 10 of the SD memory card by performing the write protocol. In FIG. 12, the pin 5 is used to input clock signals generated in the card writer 101 to the SD memory card. The controller 20 receives the clock signals via the pin 5 for synchronous control between the card writer 101 and the SD memory card. The controller 20 receives from the card writer 101 the data to be written into the SD memory card via the pins 7-9 as well as the pin 1. The controller 20 further receives a command from the card writer 101 via the pin 2. In addition, the controller 20 transmits a response to the card writer 101 via the pin 2.

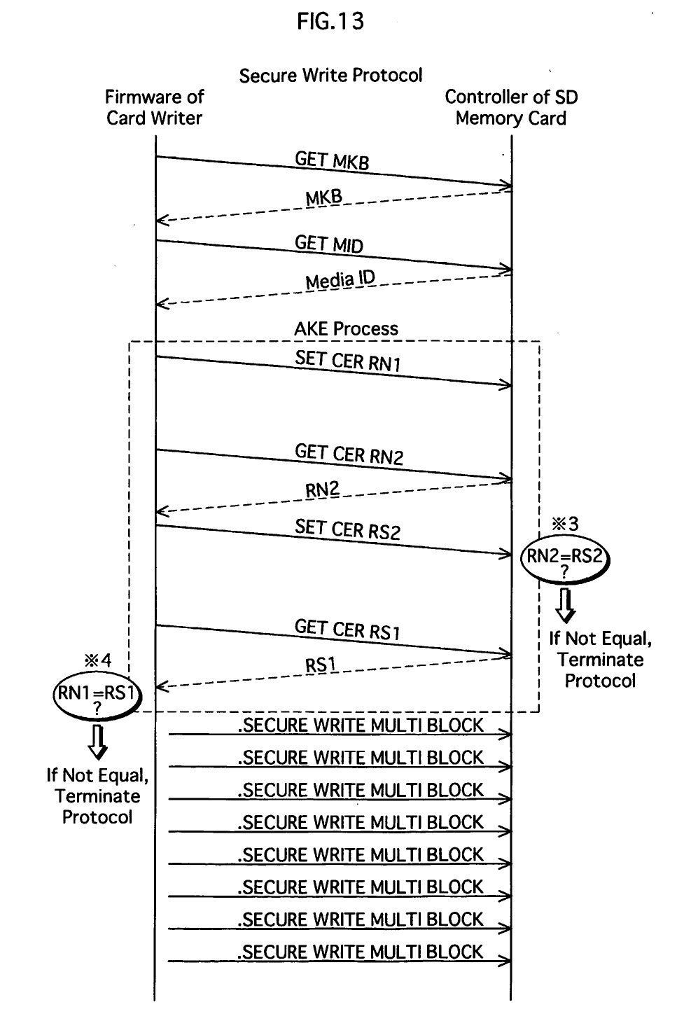

Now, description is given to the write protocol performed to write data into the SD memory card. The write protocol performed to write data into the protected area 25 greatly differs from the one performed to write data into the user data area 26. The protocol for writing data into the user data area 26 merely involves that the card writer 101 issues a write command. On the contrary, the write protocol for writing data into the protected area 25 requires issuance of a write command in compliance with a so-called secure write protocol. FIG. 13 shows the sequence of the secure write protocol. In the figure, the vertical axis schematically represents a time axis, and each arrow (in a solid line) directed from the card writer 101 to the SDmemorycard schematically represents a command issued from the firmware 40. Each arrow directed from the SD memory card to the card writer 101 schematically represents a response from the controller 20 included in the SD memory card. In the figure, the indication “SECURE WRITE MULTI BLOCK” represents a write command. As apparent from the figure, there are a number of operations to be performed in the secure write protocol before the SECURE WRITE MULTI BLOCK command.

The “GET MKB” command is to read the MKB stored in the system area of the SD memory card. Upon obtaining the MKB at this command, the firmware 40 of the card writer 101 performs the predetermined calculation using the device key Kd provided by the manufacturer and the MKB, thereby obtaining a 56-bit encryption key Km.

The “GET MID” command is to read the Media-ID (MID) stored in the system area of the SD memory card. The firmware 40 performs the predetermined calculation using the MID and Km, thereby obtaining a 64-bit output. The last 56 bits of the output are designated as an encryption key Kmu.

In the figure, the part enclosed in the doted box represents an Authentication and Key Exchange (AKE) processing. In the AKE processing, the card writer 101 and the SD memory card mutually perform challenge-response type authentication to verify their respective authenticity. Upon failing to verify their respective authenticity, the processing is terminated. Upon successfully establishing the mutual authenticity, the encryption key (session key Ks) is shared between the card writer 101 and the SD memory card.

The “SET CER RN1” command is to send a challenge value RN1 to the controller 20 of the SD memory card. The challenge value RN1 is a random number generated and encrypted using Kmu at the end of the writing apparatus.

The “GET CER RN2” command is to direct the SD memory card to return a challenge value RN2 to the card writer 101. The challenge value RN2 is a random number generated and encrypted at the end of memory card by the controller 20.

The “SET CER RS2” command is to return a response value RS2 in return for the challenge value RN2 to the controller 20 of the SD memory card. The response value RS2 is obtained by the firmware 40 decrypting the challenge value RN2 using Kmu. Upon receipt of the return value RS2, the controller 20 judges as shown in the figure by the reference mark ⋄3 whether the challenge value RN2 and the response value RS2 are equal to each other. If the values are not equal to each other, the controller 20 of the SD memory card terminates the AKE processing.

The “GET CER RS1” command is to direct the controller 20 of the SD memory card to return a response value RS1 in return for the challenge value RN1. The response value RS1 is obtained by the controller 20 decrypting the challenge value RN1 using Kmu. Upon receipt of the response value RS1, the firmware 40 of the card writer 101 judges as shown in the figure by the reference mark ⋄4 whether the challenge value RN1 and the response value RS1 are equal to each other. If the values are not equal to each other, the firmware 40 of the card writer 40 terminates the AKE processing.

When the card writer 101 and the controller 20 mutually verifies their respective authenticity, the card writer 101 and the controller 20 perform an exclusive OR operation of the challenge value RN1 and the challenge value RN2 described above, and encrypts the resulting value using Kmu to obtain the session key Ks.

The “SECURE WRITE MULTI BLOCK” command is to write data into the protected area 25. The write operation by the SECURE WRITE MULTI BLOCK command is performed by the block (512 bites). The data to be written into the protected area 25 is encrypted using the 56-bit session key Ks by every 512 bits, and sent to the SD memory card by the SECURE WRITE MULTI BLOCK command. With the SECURE WRITE MULTI BLOCK command, it is possible to specify (1) the number of blocks to be written, (2) the writing mode, and (3) the writing address. The writing mode shows whether the data to be written is shared among a plurality of applications. The data shared among a plurality of applications is, for example, a master boot record, a partition table, a file allocation table, and a directory entry. The data not shared among a plurality of applications is the usage condition information and the encryption key.

Upon receipt of the command with the specifications, the controller 20 of the SD memory card decrypts the encrypted data blocks using the session key that the SD memory card has, thereby obtain the original data. The controller 20 then writes the decrypted data into the protected area 25 within EEPROM 22.

In the second embodiment described above, when the sliding member 1 is set in the second position, it is prohibited to write data into the user data area 26 i.e., the area other than the protected area 25. Thus, the encrypted contents stored in the user data area 26 are protected from being unintentionally deleted or overwritten. In addition, even when the sliding member 1 is set in the second position, it is still possible to overwrite the usage condition information stored in the protected area 25. Thus, the number of times permitted for playback or copying in the usage condition information is incremented or decremented when the content is used (played back or copied).

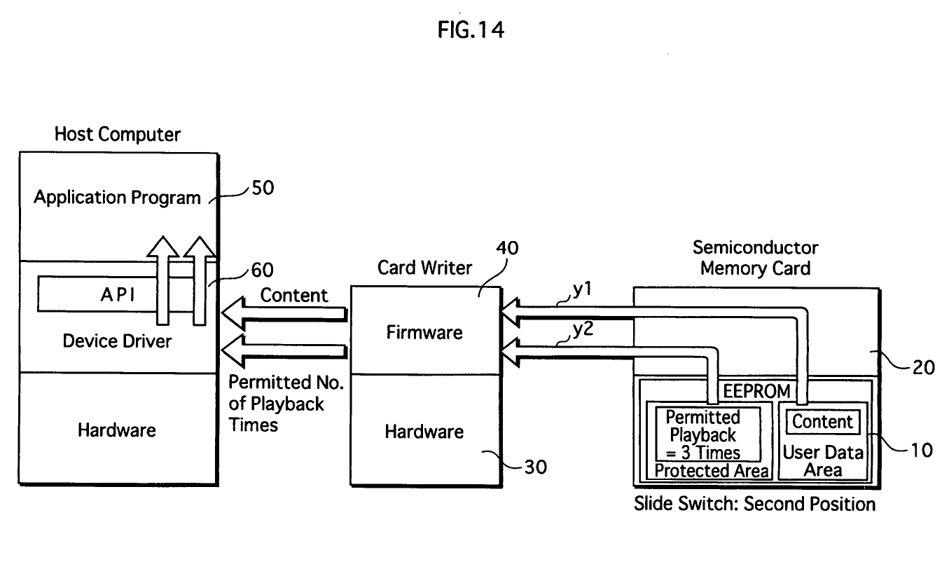

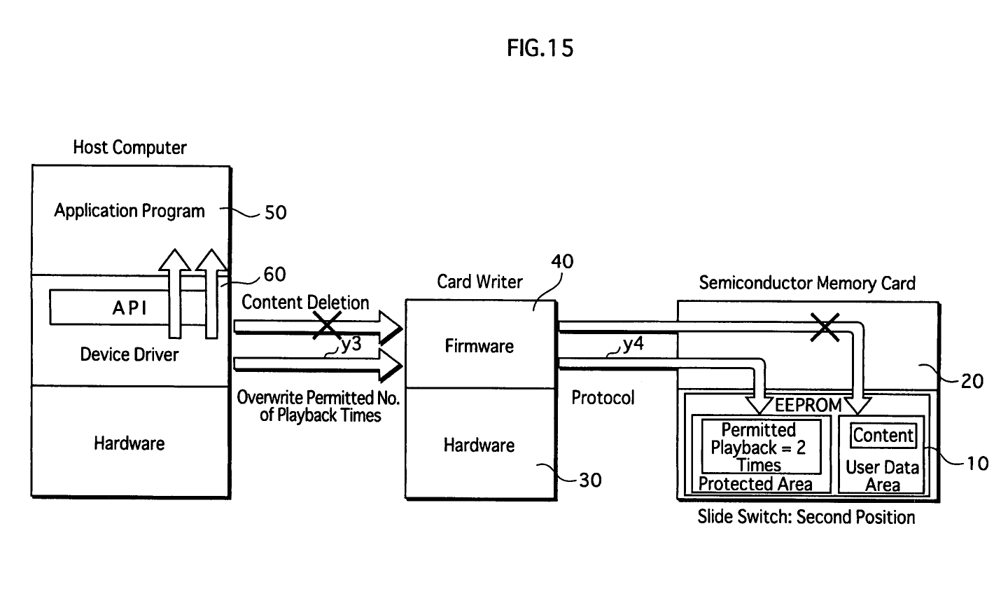

Now, description is given to the updating processing of the usage condition information as above with reference to FIGS. 14 and 15. FIG. 14 is a view showing the operations performed to read the content and the usage condition information from the SD memory card. When copying or playback of a content is requested, the content is read from the user data area 26 and the usage condition information is read from the protected area 25 as shown by arrows y1 and y2, respectively. The read content and usage condition are passed to the application program 50 in the host computer 100 via the firmware 40 and the device driver 60. The host computer 100 then plays back the content using the passed content and the usage condition information. (Generally speaking, the content is encrypted and the encryption key for the content is stored in the protected area 25, thus the encryption key is read from the protected area 25 along with the usage condition information.)

FIG. 15 is a view showing the operations performed to write data into the SD memory card. Suppose that the sliding member 1 of the SD memory card is set in the second position, any write operation to write data to the user data area 26 are prohibited, including a write operation to delete the content stored in the user data area. The reference mark “X” in the figure schematically represents that writing to the user data area 26 is totally prohibited. With this setting, unintentional deletion of data is avoided while allowing write operations to the protected area 25. As indicated by arrows y3 and y4 in the figure, the permitted number of times to play back the content is changed from three times to two times.

As described above, according to this embodiment, contents recorded in the user data area 26 are protected from unintentional deletion while allowing the usage content information recorded in the protected area 25 to be updated when usage of the content takes place. This makes it possible to develop system applications capable of updating a permitted number of playback times or of copying although a memory card is set to a non-writable state by the sliding member 1 in such a position.

### Third Preferred Embodiment

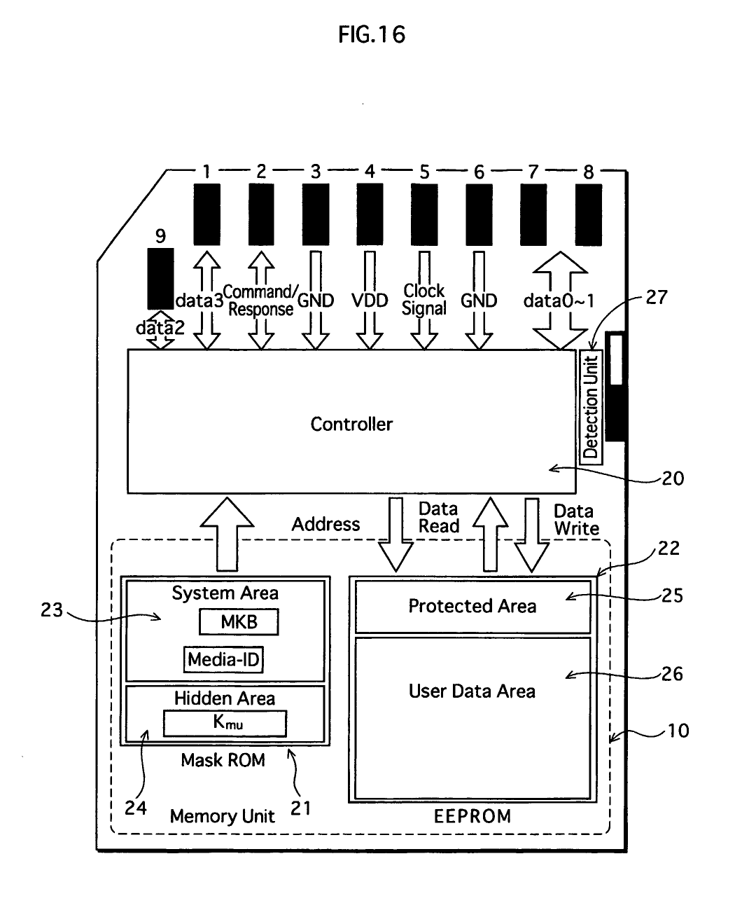

In the first and second embodiments, it is the device driver 60 that manages the stated of the memory card by generating the state information indicating either the writable or non-writable condition depending on the position of the sliding member 1. In a third preferred embodiment, however, the card controller 20 of the SD memory card detects the writable or non-writable state that the sliding member 1 indicates. As described in the first embodiment, it is difficult to provide a mechanism to connect/disconnect the internal circuit of the semiconductor memory card 102. Yet, feature technological advance may provide a semiconductor memory card having such a function, and this embodiment is directed to such a semiconductor memory card. FIG. 16 is a view showing the internal construction of an SD memory card consistent with this embodiment. The SD memory card shown in this figure includes a detection unit 27 for detecting the position of the sliding member 1 of the slide switch. Based on detection by the detection unit 27, the controller 20 recognizes whether the SD memory card is in the writable state or the non-writable state.

When the SD memory card is in the writable state, the writing apparatus writes data into the user area 26 and the protected area 25. When the SD memory card is in the non-writable state with exception, the writing apparatus writes data by performing the secure may write protocol described in the second embodiment, but do not perform any write operation to the user data area 26. In other words, similarly to the first and second embodiments, the protected area 25 is writable even when the sliding member 1 is set in the second position.

As described above, according to this embodiment, it is the controller 20 that performs operations to set the SD memory card to the writable or non-writable state as indicated by the position of the sliding member 1. Therefore, even if the writing apparatus is not provided with the device driver 60 or the card writer 101, the write operations are performed similarly to the first and second embodiments.

The data structure and various operations disclosed in this embodiment are based on the international publications listed below. For the techniques in more details, see these publications.

WO 00/65602 published on Nov. 2, 2000

WO 00/74054 published on Dec. 7, 2000

WO 00/74059 published on Dec. 7, 2000

WO 00/74060 published on Dec. 7, 2000

WO 01/16821 published on Mar. 8, 2001

Up to this point, the above description is given to the specific embodiments, yet the embodiments described above are merely examples which likely to achieve the best effect. Various modifications may be made without departing from the principles of the present invention. The following describe exemplary modifications, (A) through (J).

(A) In the first and second embodiments, it is the device driver 60 that manages the state of the memory card by generating the state information representing the writable or non-writable state depending on the position of the sliding member 1. Yet, the state management may be performed by the firmware 40 of the card writer 101.

(B) In the above embodiments, setting of the writable or non-writable state is indicated by the position of the sliding member 1. Yet, the setting may be indicated using any other component as long as it is operated manually by the user. For example, a reflecting sticker may be placed or a specific component (like a lug provided for a cassette tape) may be removed to indicate the setting.

(C) In the first and second embodiments, the card writer 101 and the host computer 100 are provided as separate devices. Alternatively, it is possible to provide the card writer 101 within the host computer 100. In addition, alternatively to the writing device composed of the host computer 100 and the card writer 101, the writing device may be a consumer mobile device, a STB (Set Top Box), or a mobile phone.

(D) The feature of the writing device consistent with the first embodiment may be embodied by a computer readable program executing the operations in accordance with the flowchart shown in FIG. 8. Thus, the program incorporating the feature operations may be embodied separately from and independently of the apparatuses consistent with the first embodiment. For example, such a program may be embodied alone by storing the program into a computer readable recording medium and giving or renting the recording medium. Also, such a program may be embodied through distributing the program over a network.

(E) It goes without saying that the usage condition information to be recorded in the SD memory card may regard to any types of contents including electronic publications, music, and movies.

(F) In the second embodiment, the usage condition information is recorded in the protected area 25. Yet, information to be recorded therein may be other confidential information, such as accounting information, personal information, and trade secret information.

(G) In the above embodiments, the usage condition information includes the limitations on copying or playback of a corresponding content. Yet, when the content may be copied in various manners such as move, migrate and check-out, the usage condition information may include separate limitations on each type of copying.

Note that move is one way of copying that involves deletion of the original content, and used to move the content from one recording medium to another.

Migrate is another way of copying that involves generation of the usage condition information at an end that the content is copied.

Check-out is copying that is performed only a set number of times, so that copying is performed after the permitted number of times is decremented. The check-out type copying differs from the so-called number-limited type copying in that the permitted number of times may be incremented. The processing of incrementing the permitted number of times is performed when processing to disable the content having been recorded in the recording medium by way of copying (this processing is referred to as “check-in”).

(H) The usage condition information may include other types of usage condition permitting usage of the content in other manners. For example, as in the second embodiment, the permitted number of copying of playback times may be set. Alternatively, a remaining usage period permitted for the content, or an upper limit to playback time or an expiry (by year, month and day) for a usage permission period may be set. In the case the usage condition information includes an upper limit to the number of times to use the content, an upper limit to the time period to use the content, or an expiry date, the writing apparatus writes into the protected area the current number of times that the content has been used, the current total time that the content has been used, or the current date.

(I) In the first and second embodiments, the semiconductor memory card is described to have the slide switch. Yet, such a semiconductor memory card is merely an example of a recording medium, and any other recording medium is applicable as long as it is provided with a switch that is manually operable by a user. The examples include a compact flash card, a smart medium, a memory stick, a multimedia card, and a PCM-CIA card. Further, the examples are not limited to a semiconductor memory card, and the following is also applicable as long as it is housed in a cartridge provided with a slide switch: (i) a magnetic recording disk, such as a flexible disk or a SuperDisk, Zip, Click?, (ii) a removable hard disk drive, such as ORB, Jaz, SparQ, SyJet, EZ Fley, or a micro drive, or (iii) an optical disk, such as DVD−RAM, DVD−RW, PD, DVD+RW, CD−RW, and the like.

(J) In the first through third embodiments above, the protected area 25 is writeable even when the sliding member 1 is in the second position. Alternatively to setting the entire protected area 25 to the writable state, a specific area within the protected area 25 may be set to the writable state. For example, specific files recorded in the protected area may be set to the writable state. System applications usually rewrite specific files such as the one containing usage condition information. Thus, it is effective to selectively set those specific files that possibly need to be rewritten to the writable state, thereby more reliably preventing corruption of the data in the protected area 25. Alternatively, the protected area 25 is set to the writable state only in part of its address space.

### Industrial Applicability

Since the present invention allows system applications to freely write data into the protected area without requiring the user to change the slide switch setting, it is possible to introduce into the market the writing apparatuses that are likely to be approved by users. For this advantage, a writing apparatus, a writing program, and a writing method consistent with the present invention have great potential for use in consumer-oriented manufacturing industries and other industries.

1. A writing apparatus that writes data into a user area within a semiconductor memory card according to an instruction issued by an application program, the writing apparatus comprising:
a recognition unit operable to recognize the user area to be in a writable state or in a non-writable state depending on a position of a sliding member, the sliding member being exposed on a surface of the semiconductor memory card and being manually slidable;
a write unit operable to write data into the user area in the writable state, and when the user area is in the non-writable state, to perform an exceptional write operation, wherein
the exceptional write operation is performed according to a special write command issued by the application program to write data into a memory area within the semiconductor memory card that is different from the user area.

2. The writing apparatus of claim 1, wherein
the semiconductor memory card has an authentication circuit,
the special write command includes (i) an instruction for directing the writing apparatus to authenticate the semiconductor memory card, and (ii) an instruction for directing the authentication circuit of the semiconductor memory card to authenticate the writing apparatus, and
the exceptional write operation is performed only when the writing apparatus and the semiconductor memory card are authenticated mutually and successfully.

3. The writing apparatus of claim 2, wherein
the user area has a content recorded therein,
the different memory area is a protected area having usage condition information recorded therein, the usage condition information corresponding to the content, and
the special write command is issued when a new value is to be written in the protected area to update the usage condition information.

4. The writing apparatus of claim 3, wherein
usage of the content is to play back or copy the content,
the usage condition information includes a permitted number of playback times or a permitted number of copying times for the content, and
the new value written to update the usage condition information is the permitted number of playback times or the permitted number of copying times that has been incremented or decremented in response to playback or copying of the content performed.

5. The writing apparatus of claim 1, further comprising a judgment unit operable to judge whether the semiconductor memory card is of a first type or a second type, wherein
the write unit does not perform the exceptional write operation when the semiconductor memory card is of the second type and the user area is in the non-writable state, and performs the exceptional write operation when the semiconductor memory card is of the first type and the user area is in the non-writable state.

6. The writing apparatus of claim 5, wherein
the semiconductor memory card of the first type has an authentication circuit,
the semiconductor memory card of the second type has no authentication circuit,
the special write command instructs (i) the writing apparatus to authenticate the semiconductor memory card, and (ii) the authentication circuit of the semiconductor memory card to authenticate the writing apparatus, and
the exceptional write operation is performed only when the writing apparatus and the semiconductor memory card are mutually authenticated.

7. A semiconductor memory card, comprising:
a sliding member being exposed on a surface of the semiconductor memory card and being manually slidable;
a non volatile memory having a user area and a protected area; and
a recognition unit operable to recognize the user area to be in a writable state or in a non-writable state depending on a position of the sliding member, wherein
the protected area is exceptionally writable according to a special write command issued by an application program even when the user area is in the non-writable state.

8. The semiconductor memory card of claim 7, further comprising an authentication circuit, wherein
the special write command includes (i) an instruction for directing the writing apparatus to authenticate the semiconductor memory card, and (ii) an instruction for directing the authentication circuit of the semiconductor memory card to authenticate the writing apparatus, and
the protected area is exceptionally writable only when the writing apparatus and the semiconductor memory card are authenticated mutually and successfully.

9. The semiconductor memory card of claim 8, wherein
the user area has a content recorded therein,
the protected area has usage condition information recorded therein, the usage condition information corresponding to the content, and
the special write command is issued when a new value is to be written in the protected area to update the usage condition information recorded.

10. The semiconductor memory card of claim 9, wherein
usage of the content is to play back or copy the content,
the usage condition information includes a permitted number of playback times or a permitted number of copying times for the content, and
the new value written to update the usage condition information is the permitted number of playback times or the permitted number of copying times that has been incremented or decremented in response to playback or copying of the content performed.

11. A computer readable program for having a computer perform a write operation to write data into a user area within a semiconductor memory card according to an instruction issued by an application program, comprising:
a recognition step of recognizing the user area to be in a writable state or in a non-writable state depending on a position of a sliding member, the sliding member being exposed on a surface of the semiconductor memory card and being manually slidable; and
a write step of writing data into the user area in the writable state, and when the user area is in the non-writable state, to perform an exceptional write operation, wherein
the exceptional write operation is performed according to a special write command issued by the application program to write data into a memory area within the semiconductor memory card that is different from the user area.

12. The computer readable program of claim 11, wherein
the semiconductor memory card has an authentication circuit,
the special write command includes (i) an instruction for directing the writing apparatus to authenticate the semiconductor memory card, and (ii) an instruction for directing the authentication circuit of the semiconductor memory card to authenticate the writing apparatus, and
the exceptional write operation is performed only when the writing apparatus and the semiconductor memory card are authenticated mutually and successfully.

13. The computer readable program of claim 12, wherein
the user area has a content recorded therein,
the different memory area is a protected area having usage condition information recorded therein, the usage condition information corresponding to the content, and
the special write command is issued when a new value is to be written in the protected area to update the usage condition information.

14. The computer readable program of claim 13, wherein
usage of the content is to play back or copy the content,
the usage condition information includes a permitted number of playback times or a permitted number of copying times for the content, and
the new value written to update the usage condition information is the permitted number of playback times or the permitted number of copying times that has been incremented or decremented in response to playback or copying of the content performed.

15. The computer readable program of claim 11, further comprising a judgment step of judging whether the semiconductor memory card is of a first type or a second type, wherein
the write step does not perform the exceptional write operation when the semiconductor memory card is of the second type and the user area is in the non-writable state, and performs the exceptional write operation when the semiconductor memory card is of the first type and the user area is in the non-writable state.

16. The computer readable program of claim 15, wherein
the semiconductor memory card of the first type has an authentication circuit,
the semiconductor memory card of the second type has no authentication circuit,
the special write command instructs (i) the writing apparatus to authenticate the semiconductor memory card, and (ii) the authentication circuit of the semiconductor memory card to authenticate the writing apparatus, and
the exceptional write operation is performed only when the writing apparatus and the semiconductor memory card are mutually authenticated.

17. A recording medium storing the program of claim 11.

18. A method for writing data into a user area within a semiconductor memory card according to an instruction issued by an application program, comprising:
a recognition step of recognizing the user area to be in a writable state or in a non-writable state depending on a position of a sliding member, the sliding member being exposed on a surface of the semiconductor memory card and being manually slidable; and
a write step of writing data into the user area in the writable state, and when the user area is in the non-writable state, to perform an exceptional write operation, wherein
the exceptional write operation is performed according to a special write command issued by the application program to write data into a memory area within the semiconductor memory card that is different from the user area.

19. The method of claim 18, wherein
the semiconductor memory card has an authentication circuit,
the special write command includes (i) an instruction for directing the writing apparatus to authenticate the semiconductor memory card, and (ii) an instruction for directing the authentication circuit of the semiconductor memory card to authenticate the writing apparatus, and
the exceptional write operation is performed only when the writing apparatus and the semiconductor memory card are authenticated mutually and successfully.

20. The method of claim 19, wherein
the user area has a content recorded therein,
the different memory area is a protected area having usage condition information recorded therein, the usage condition information corresponding to the content, and
the special write command is issued when a new value is to be written in the protected area to update the usage condition information.

21. The method of claim 20, wherein
usage of the content is to play back or copy the content,
the usage condition information includes a permitted number of playback times or a permitted number of copying times for the content, and
the new value written to update the usage condition information is the permitted number of playback times or the permitted number of copying times that has been incremented or decremented in response to playback or copying of the content performed.

22. The method of claim 18, further comprising a judgment step of judging whether the semiconductor memory card is of a first type or a second type, wherein
the write step does not perform the exceptional write operation when the semiconductor memory card is of the second type and the user area is in the non-writable state, and performs the exceptional write operation when the semiconductor memory card is of the first type and the user area is in the non-writable state.

23. The method of claim 22, wherein
the semiconductor memory card of the first type has an authentication circuit,
the semiconductor memory card of the second type has no authentication circuit,
the special write command instructs (i) the writing apparatus to authenticate the semiconductor memory card, and (ii) the authentication circuit of the semiconductor memory card to authenticate the writing apparatus, and
the exceptional write operation is performed only when the writing apparatus and the semiconductor memory card are mutually authenticated.
